(19) United States
(12) Patent Application Publication
(10) Pub. No.: US 2013/0275470 A1
(43) Pub. Date: Oct. 17, 2013

(54) LOCAL ACCESS TO CLOUD-BASED STORAGE

(71) Applicants: Junwei Cao, Beijing (CN); Fan Zhang, Beijing (CN)

(72) Inventors: Junwei Cao, Beijing (CN); Fan Zhang, Beijing (CN)

(73) Assignee: EMPIRE TECHNOLOGY DEVELOPMENT LLC, Wilmington, DE (US)

(21) Appl. No.: 13/820,455

(22) PCT Filed: Feb. 16, 2012
(86) PCT No.: PCT/CN2012/071213

§ 371 Date: Mar. 1, 2013

(51) Int. Cl. G06F 21/62

(52) U.S. Cl. CPC G06F 21/6218
USPC 707/781

(57) ABSTRACT

In one example of local access to cloud-based storage, a computer-readable medium stores one or more executable instructions that, when executed, cause one or more processors to subscribe to a cloud service provider, store a digital catalog to the cloud service provider, register a point of access for at least a portion of the digital catalog with the cloud service provider, and receive expedited access to at least the portion of the digital catalog at the registered point of access.

### TECHNICAL FIELD

The implementations and embodiments described herein pertain generally to cloud-based storage services.

### BACKGROUND

Cloud-based storage refers to online storage by which data is virtually stored across multiple servers, which are typically hosted by service providers. The service providers include data center operators, which virtualize resources based on customer requirements. The storage services may be accessed via web service application programming interfaces (API) or via web-based user interfaces (UI).

### SUMMARY

In one example embodiment, a computer-readable medium stores one or more executable instructions that, when executed, cause one or more processors to subscribe to a cloud service provider, store a digital catalog to the cloud service provider, register a point of access for at least a portion of the digital catalog with the cloud service provider, and receive expedited access to at least the portion of the digital catalog at the registered point of access.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which local access to cloud-based storage may be implemented, arranged in accordance with at least some embodiments described herein;

FIG. 2 shows an example configuration of an application by which local access to cloud-based storage may be implemented, arranged in accordance with at least some embodiments described herein;

FIG. 3 shows an example configuration of a cloud-based service provider for implementing local access to cloud-based storage, arranged in accordance with at least some embodiments described herein;

FIG. 4 shows an example processing flow for implementing local access to cloud-based storage, arranged in accordance with at least some embodiments described herein;

FIG. 5 shows a block diagram illustrating an example computing device by which various example solutions described herein may be implemented, arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

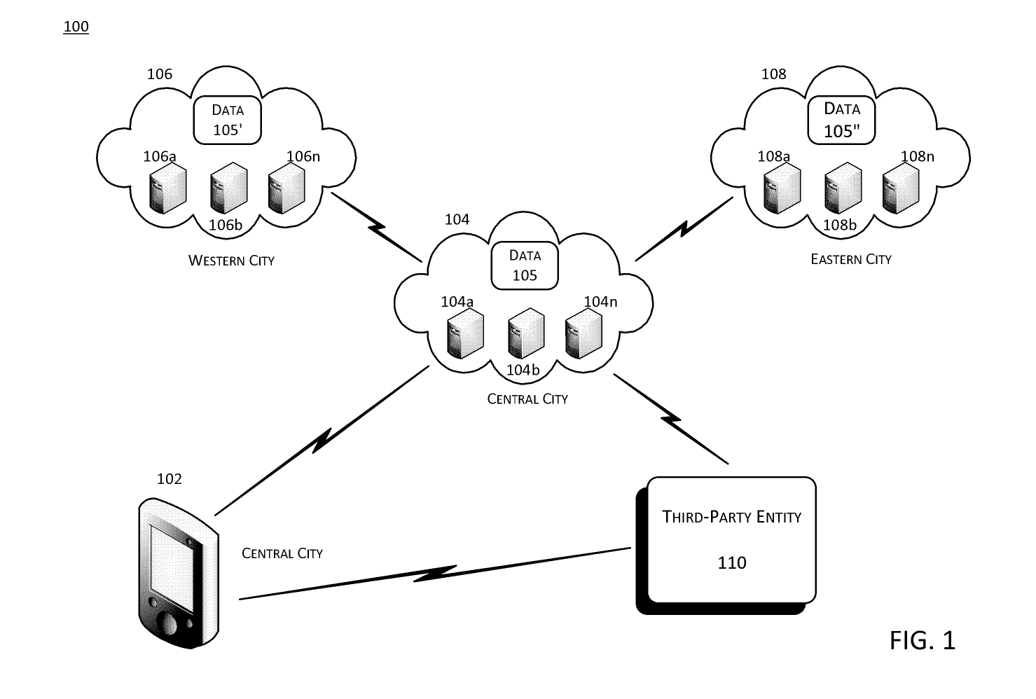

FIG. 1 shows an example system configuration 100 in which local access to cloud-based storage may be implemented, arranged in accordance with at least some embodiments described herein. As depicted, configuration 100 may include a mobile client 102, cloud-based service and data centers 104, 106, and 108, and a third-party entity 110. Three cloud-based service and data centers and one third-party entity are shown in FIG. 1 for simplicity and one skilled in the art will appreciate that there may be a different number of cloud-based service and data centers and/or third-party entities.

Mobile client 102 may refer to a computing device that may be implemented as a portion of a small-form factor portable (or mobile) electronic device such as a mobile phone or smartphone, or, alternatively, a personal data assistant (PDA), a personal media player device, an application specific device such as a tablet or slate computing device, or a hybrid device that may include any of the above functions. Mobile client 102 may also be implemented as a personal computer including both laptop computer and non-laptop computer configurations.

Mobile client 102 may be communicatively coupled to cloud-based service and data centers 104, 106, and 108, and/or third party entity 110 via, e.g., at least a wireless local area network technology (WLAN), i.e., Wi-Fi. However, embodiments of local access to cloud-based storage are not limited to wireless communications, and therefore hard-wired communications may also apply to the embodiments described herein.

Cloud-based service and data center 104 may be included as part of a cloud-based storage provider, which may be an infrastructure having multiple servers 104a, 104b, . . . , 104n that include, e.g., computer hardware and computer software, configured to store data 105 and further configured to deliver cloud-based storage services. The cloud storage provider infrastructure may include one or multiple blocks of storage.

Accordingly, the private cloud infrastructure depicted as part of configuration 100 may further include: cloud-based service and data center 106 having multiple servers 106a, 106b, . . . , 106n to receive, store, and transmit data 105′, which may be copies of data 105; and cloud-based service and data center 108 having multiple servers 108a, 108b, . . . , 108n to receive, store, and transmit data 105″, which also may be copies of data 105. Of course, the infrastructure for a cloud-based storage provider for implementing local access to cloud-based storage is in no way limited to the embodiments depicted as part of configuration 100. Quantities of, e.g., cloud-based service and data centers and servers hosted thereon or otherwise associated therewith, as well as a locality for data 105 or virtualizations thereof, may vary from one embodiment to another, without departing from the spirit or scope of local access to cloud-based storage, as described herein.

Further, the private cloud infrastructure that includes cloud-based service and data centers 104, 106, and 108 may be operated for a single organization, and may be managed internally by the single organization and hosted internally or externally. Non-limiting examples of such organizations that operate, manage, and/or host such an infrastructure may include, but not be limited to, Amazon®, Microsoft®, Google®, IBM®, etc.

As depicted in configuration 100, cloud-based service and data centers 104, 106, and 108 may be disposed in geographically disparate locations to satisfy the storage and access demands of subscribers to the cloud-based storage services offered by the cloud-based storage provider. To illustrate this point, cloud-based service and data center 104 is depicted as being located in, or otherwise associated with, “Central City;” cloud-based service and data center 106 is depicted as being located in, or otherwise associated with, “Western City;” and cloud-based service and data center 108 is depicted as being located in, or otherwise associated with, “Eastern City.” Central City, Western City, and Eastern City may be located in different countries, in different states or provinces, or in different cities within the same state or province.

Further, mobile client 102 is depicted as being, initially, located in Central City or otherwise associated or communicatively coupled to the servers 104a, 104b, . . . , 104n hosted on or otherwise associated with cloud-based service and data center 104 corresponding to Central City.

Data 105 may refer to data that is owned or otherwise associated with a user of mobile client 102. Such data may include data files such as, but not limited to, text, pictures, videos, music/audio, etc. Further, data 105′ stored on one or more servers hosted at or otherwise associated with cloud-based service and data center 106 and data 105″ stored on one or more servers hosted on or otherwise associated with cloud-based service and data center 108 may be copies of data 105.

Third party entity 110 may refer to an entity that is configured to be communicatively coupled to at least one of mobile client 102 or one or more of cloud-based service and data centers 104, 106, and 108 corresponding to the cloud-based storage provider to which the user of mobile client 102 has subscribed. As depicted in the non-limiting example embodiment of FIG. 1, third party entity 110 is communicatively coupled to mobile client 102 and cloud-based service and data center 104.

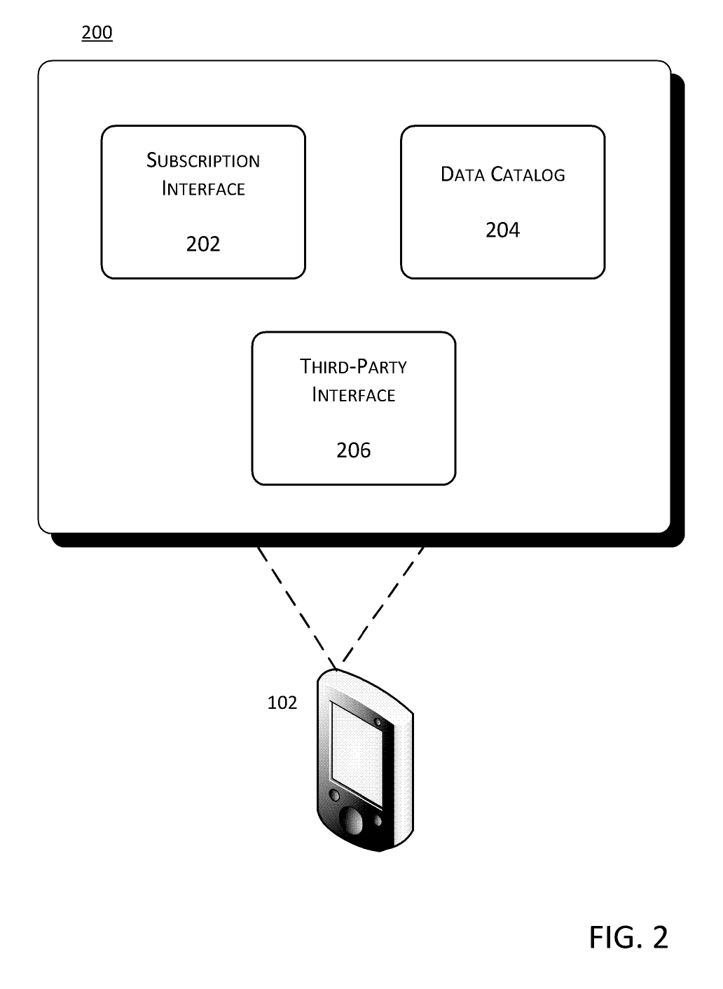

FIG. 2 shows an example configuration of an application 200 by which local access to cloud-based storage may be implemented, arranged in accordance with at least some embodiments described herein. Further, application 200 may include various components or modules, e.g., implemented by one or more computer-readable media including but not limited to Application Specific Integrated Circuit (ASIC) or Customer Specific Integrated Circuit (CSIC). The various components or modules corresponding to application 200 may include, but are not limited to, a subscription interface 202, a data catalog 204, and a third-party interface 206. Further, application 200 is not limited to such components or modules, as obvious modifications may be made by adding further components or modules or even eliminating at least one of the components or modules described here or even by having various components or modules assuming roles accorded to other components or modules in the following description.

As depicted in FIG. 2, application 200 may be hosted on or otherwise associated with, mobile client 102. As discussed above, mobile client 102 may be communicatively coupled to cloud-based service and data centers 104, 106, 108, and/or third party entity 110 via, e.g., at least a wireless local area network technology (WLAN), i.e., Wi-Fi. Thus, application 200 may facilitate user interaction with, at least, any cloud-based service and data center within the infrastructure of a cloud-based storage provider and any third party entity to implement local access to cloud-based storage for a user of mobile client 102.

Subscription interface 202 may represent a component or module that is configured to interface with any of multiple servers 104a, 104b, . . . , 104n hosted on or otherwise corresponding to cloud-based service and data center 104; multiple servers 106a, 106b, . . . , 106n hosted on or otherwise corresponding to cloud-based service and data center 106; or multiple servers 108a, 108b, . . . , 108n hosted on or otherwise corresponding to cloud-based service and data center 108 that serve as a controller for the cloud-based storage provider.

More particularly, subscription interface 202 may enable the user of mobile client 102 to subscribe to, or purchase, one or more tiers of a layered subscription scheme offered by the cloud-based storage provider. That is, the cloud-based storage provider may offer, and the user of mobile client 102 may subscribe to, various tiers of cloud-based storage services that include a hierarchy of services based on, e.g., storage space, bandwidth, user-specified priority, etc. The examples of categories of tiers are non-limiting, of course, and pricing for subscriptions or purchases of such tiered services may vary from one tier of service to another.

Data catalog 204 may represent a component or module that is configured to provide the user of mobile client 102 with a view of data 105, 105′, and/or data 105″ stored at or corresponding to, respectively, cloud-based service and data centers 104, 106, and 108. Data 105, and therefore data 105′ and data 105″, may be categorized and/or prioritized in accordance with the tier of cloud-based storage service to which the user of mobile client 102 has subscribed or purchased.

More particularly, data 105, and therefore data 105′ and data 105″, may be categorized based on type of data including, but not limited to, digital video, digital audio, or text. Further, individual files amongst data 105, 105′, and 105″ may be prioritized based on the user's preference, with the prioritization being within the context of the comprehensive collection of data 105, 105′, and 105″ or within the context of the aforementioned data type categories. Thus, the categorization and prioritization of data 105 may be static and constant as applied to virtual copies thereof, e.g., data 105′ and data 105″.

However, alternative embodiments of local access to cloud-based storage may contemplate data 105, data 105′, and data 105″ being categorized and prioritized separately from one another. That is, the categorization and/or prioritization of data may be dynamic. As a non-limiting example, if the user of mobile client 102 lives in Central City, data 105 may be categorized and prioritized so that digital music files within the catalog of data 105 are most highly prioritized and therefore most readily accessible for personal use. Further to the example, if the user of mobile client 102 frequently travels to Western City for work purposes, data 105′ may be categorized and prioritized so that digital text files within the catalog of data 105 are most highly prioritized and therefore most readily accessible for professional use. Further still to the example, if the user of mobile client 102 frequently travels to Eastern city for personal purposes, data 105″ may be categorized and prioritized so that digital video files within the catalog of data 105 are most highly prioritized and therefore most readily accessible for sharing with family and friends.

Regardless of the scheme of categorization and prioritization, data catalog 204 may be configured to provide the user of mobile client 102 visual accesses to various representations of the stored data via mobile client 102.

Third-party interface 206 may represent a component or module that is configured to interface with third-party entity 110.

In accordance with non-limiting examples of local access to cloud-based storage, third party entity 110 may represent an airline, a bus line, a rail service, an Internet travel service, a hotel chain, etc. that have knowledge of an intended or preferred point of data access for the user of mobile client 102. Based on the tier of storage service to which the user of mobile client 102 has subscribed or purchased, notice of the user's future point of access for data 105, and therefore data copies 105′ or 105″, may be made known to the one or more servers hosted on or otherwise associated with cloud-based service and data centers 106 or 108, respectively. Accordingly, the cloud-based storage service may make data copies 105′ or 105″ more readily accessible in anticipation of the arrival and impending access to such data by the user of mobile client 102. Accordingly, data copies 105′ or 105″ may be accessible in an expedited manner upon arrival by the user of mobile client 102 in Western City or Eastern City, respectively, depending upon the tier of service that has been subscribed to or purchased.

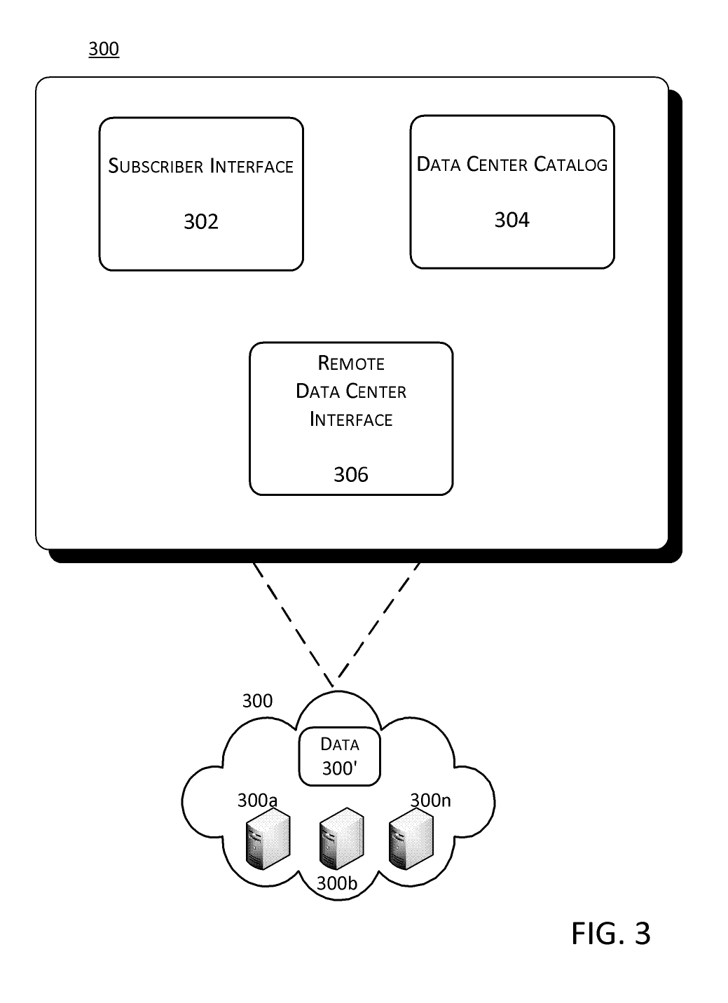

FIG. 3 shows an example configuration of a cloud-based service provider 300 for implementing local access to cloud-based storage, arranged in accordance with at least some embodiments described herein. Configuration 300 may include various components or modules, e.g., implemented by one or more computer-readable media including but not limited to Application Specific Integrated Circuit (ASIC) or Customer Specific Integrated Circuit (CSIC). The various components or modules may include, at least, a subscriber interface 302, a data center catalog 304, and a remote data center interface 306. Further, configuration 300 is not limited to such components or modules, as obvious modifications may be made by adding further components or modules or even eliminating at least one of the components or modules described here or even by having various components or modules assuming roles accorded to other components or modules in the following description.

Subscriber interface 302 may represent a component or module that is configured to interface with mobile client 102.

More particularly, subscriber interface 302 may enable the cloud-based storage provider to interface with, for example, subscription interface 202 hosted on mobile client 102 to facilitate the tier of cloud-based storage service to which the user of mobile client 102 has subscribed or purchased. Again, as non-limiting examples, the cloud-based storage provider may offer, and the user of mobile client 102 may subscribe to, various tiers of cloud-based storage services that include a hierarchy of services based on, e.g., storage space, bandwidth, or client-specified priority. The examples of categories of tiers are non-limiting, of course, and pricing for subscriptions or purchases of such tiered services may vary from one tier to another.

Subscriber interface 302 may further be configured to interface with any or all of subscription interface 202 or third-party interface 206 hosted on mobile client 102 or with third party 110 itself to coordinate the transfer or streaming of data 105 to a future or preferred point of access, e.g., cloud-based service and data centers 106 and 108 at Western City and Eastern City respectively, to expedite access to data copies, i.e., data 105′ or 105″ for the user of mobile client 102 subsequent to arrival at the registered point of access.

Remote data center interface 306 may represent a component or module that is configured to enable the servers hosted on or otherwise associated with a particular cloud-based service and data center to interact with the servers in another cloud-based service and data center. Although the current embodiments of local access to cloud-based storage are described in the context of servers 104a, 104b, . . . , 104n hosted on or associated with cloud-based service and data center 104 interacting with servers 106a, 106b, . . . , 106n hosted on or associated with cloud-based service and data center 106 and/or servers 108a, 108b, . . . , 108n hosted on or otherwise associated with cloud-based service and data center 108, whereby all of cloud-based service and data centers 104, 106, and 108 are included in the infrastructure of a single cloud-based storage provider, alternative embodiments may contemplate cloud-based service and data centers 104, 106, and/or 108 being associated with different, i.e., owned by different entities, cloud-based storage providers. Accordingly, remote data center interface 106 may facilitate intra-cloud interaction or inter-cloud interaction.

More particularly, remote data center interface 306 may represent a component or module that is configured to stream or receive copies of data owned or otherwise associated with a subscriber to a cloud-based storage service from one localized cloud-based service and data center to another. As a result, as the user of mobile client 102 moves from Central City to Western City, access to data 105, which may be reproduced as data 105′ upon streaming from cloud-based service and data center 104 to cloud-based service and data center 106 by a wired or wireless connection, may be expedited in accordance with the tier of cloud-based storage service to which the user has subscribed or purchased. Likewise, as the user of mobile client 102 moves from Central City to Eastern City, access to data 105, which may be reproduced as data 105″ upon streaming from cloud-based service and data center 104 to cloud-based service and data center 108 by a wired or wireless connection, may be expedited in accordance with the tier of storage service to which the user has subscribed or purchased.

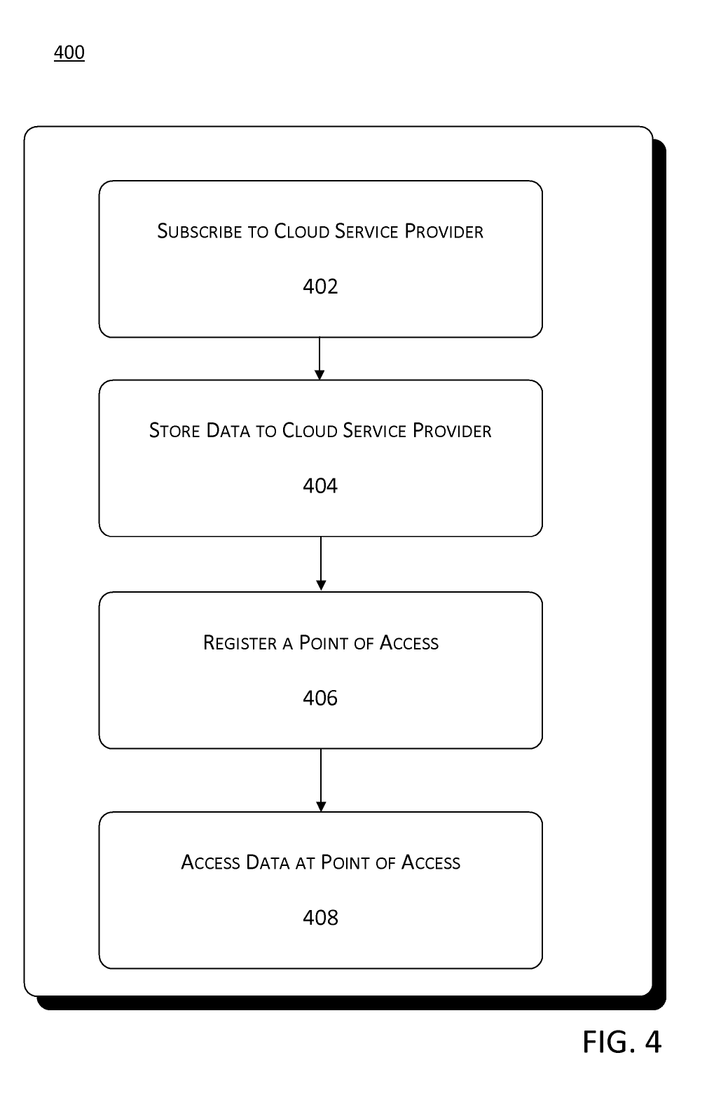

FIG. 4 shows an example processing flow 400 for implementing local access to cloud-based storage, arranged in accordance with at least some embodiments described herein. Processing flow 400 may include various operations, functions, or actions as illustrated by one or more of blocks 402, 404, 406, and/or 408.

More particularly, processing flow 400 describes sub-processes that may be executed by various components of configuration 100, including, but not limited to, application 200 hosted on or otherwise associated with mobile client 102 and cloud-based service provider 300. Processing flow 400 may begin at block 402.

Block 402 (Subscribe to Cloud Service Provider) may refer to interaction between mobile client 102 and a local cloud-based service and data center, e.g., cloud-based service and data center 104, which is included in or otherwise associated with cloud-based storage provider 300.

By way of example, at block 402, a user of mobile client 102 may utilize subscriber interface 202 on application 200 hosted on or otherwise associated with mobile client 102 to subscribe to, or purchase, one or more tiers of a layered subscription scheme offered by the cloud-based storage provider 300. As depicted in FIGS. 1-3, such interaction may be facilitated between mobile client 102 and one or more of servers 104a, 104b, . . . , 104n hosted on or otherwise associated with cloud-based service and data center 104.

The various tiers of cloud-based storage services to which the user of mobile client 102 may subscribe or purchase may include a hierarchy of services based on, e.g., storage space, bandwidth, and user-specified priority. The examples of categories of tiers are non-limiting, of course, and pricing for subscriptions or purchases of such tiered services may vary from one tier to another. Processing may continue from block 402 to block 404.

Block 404 (Store Data to Cloud Service Provider) may refer to data 105, e.g., digital video, digital audio, text, etc., being uploaded from mobile client 102 to one or more servers 104a, 104b, . . . , 104n on a localized cloud-based service and data center, e.g., cloud-based service and data center 104. However, since cloud-based storage is likely, though not exclusively, to be implemented for large volumes of data that either may not physically be stored on mobile client 102 or is otherwise impractical, block 404 may refer to data 105 being uploaded to, e.g., one or more servers 104a, 104b, . . . , 104n on localized cloud-based service and data center 104 from another source, though at directions transmitted from mobile client 102. Such other source of data 105 may be a flash drive or other storage device that may be plugged into or wirelessly, e.g., Bluetooth, connected to mobile client 102. Alternatively, the other source of data 105 may be another computing or storage device to which mobile client 102 is communicatively coupled via, e.g., at least a wireless local area network technology (WLAN), i.e., Wi-Fi. Further still, the other source of data 105 may even include cloud-based service and data centers 106 or 108.

Block 404 may further include data 105 being stored on, e.g., one or more of servers 104a, 104b, . . . , 104n hosted on or otherwise associated with cloud-based service and data center 104 in a hierarchical manner, dependent upon the classification and/or prioritization commensurate with the tier of cloud-based storage to which the user of mobile client 102 has subscribed or purchased. As set forth above, stored data 105 may be categorized based on type of data including, but not limited to, digital video, digital audio, or text. Further, individual files amongst data 105 may be prioritized based on the user's preference, with the prioritization being within the context of the comprehensive collection of data 105 or within the context of the aforementioned data type categories. Alternatively, data 105 may be stored with classification and/or prioritizations that are dependent upon the point of access, i.e., geographic location, thereof. Processing may continue from block 404 to block 406.

Block 406 (Register a Point of Access) may refer to the user of mobile client 102 registering with cloud-based storage service 300 a geographic point of access at which the user of mobile client 102 is likely to access data 105, i.e., data copies 105′ or 105″, at a future point in time.

According to one non-limiting example, the user of mobile client 102 may implement communicative interaction between subscription interface 202 and subscriber interface 302 to register a future point of access or one or more preferred points of access for data 105. Alternatively, third-party entity 110, e.g., an airline, a bus line, a rail service, an Internet travel service, a hotel chain, etc., may communicatively interact directly with subscriber interface 302, on behalf of the user of mobile client 102, to register the future point of access for data 105 upon securing a reservation or other form of registration indicating the user's intention to be so located. In yet another alternative embodiment, third-party entity 110 may so communicatively interact with subscriber interface 302 via third-party interface 206, which is hosted on or otherwise associated with mobile client 102.

Based on the registration of the future point of access or preferred points of access executed at block 406, data 105 may be streamed from one or more of servers 104a, 104b, . . . , 104n hosted on or otherwise associated with cloud-based service and data center 104 to, e.g., one or more of servers 106a, 106b, . . . , 106n hosted on or otherwise associated with cloud-based service and data center 106 or one or more of servers 108a, 108b, . . . , 108n hosted on or otherwise associated with cloud-based service and data center 108, depending upon which of cloud-based service and data centers 106 and 108 is local to the registered point of access. Processing may continue from block 406 to block 408.

Block 408 (Access Data at Point of Access) may refer to the user of mobile client 102 accessing data copies 105′ or 105″ on an expedited basis upon arrival at the registered point of access. That is, the user of mobile client 102 may access data copies 105′ or 105″ dependent upon the categorization and/or prioritization thereof which, in turn, is dependent upon the tier of cloud-based storage service to which the user of mobile client 102 has subscribed or purchased.

Accordingly, by processing flow 400 with reference to the embodiments described and suggested by FIGS. 1-3, the user of mobile client 102 may experience a high level of quality of service as data owned or otherwise associated with the user is accessible in a real-time manner, regardless of the user's geographic location, as virtualized copies of the stored data is streamed to localized data centers corresponding to a cloud-based storage service to which the user has subscribed or purchased.

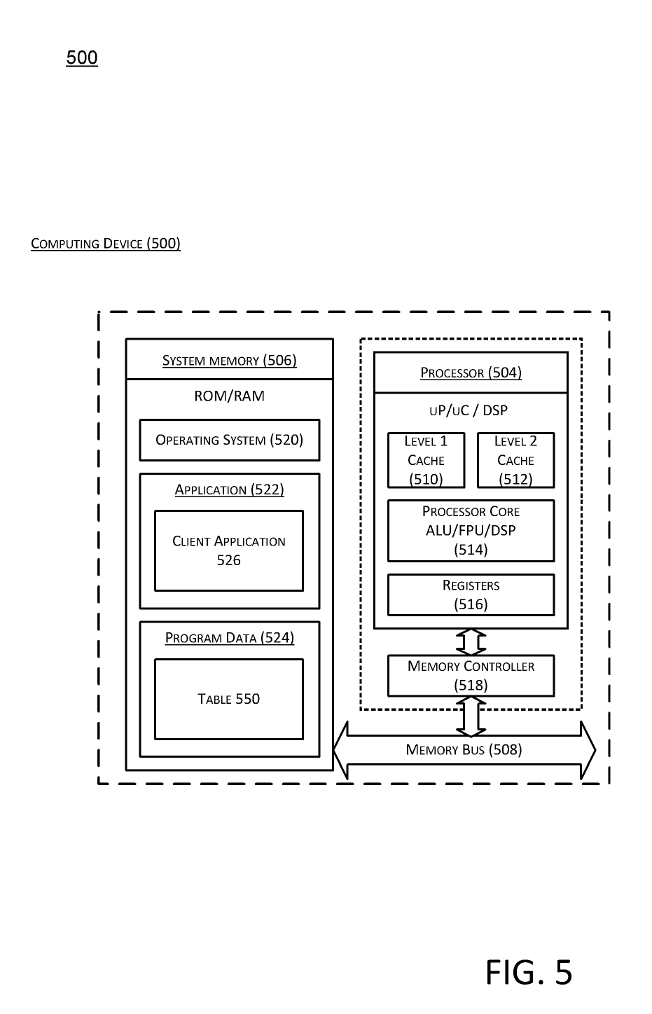

FIG. 5 shows a block diagram illustrating an example computing device 500 by which various example solutions described herein may be implemented, arranged in accordance with at least some embodiments described herein.

More particularly, FIG. 5 shows an illustrative computing embodiment, in which any of the processes and sub-processes described herein may be implemented as computer-readable instructions stored on a computer-readable medium. The computer-readable instructions may, for example, be executed by a processor of a mobile unit, a network element, and/or any other computing device, particularly as applicable to the applications and/or programs described above corresponding to the configuration 100 for masking phone numbers.

In a very basic configuration, a computing device 500 may typically include one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. Processor 504 may include one or more levels of caching, such as a level one cache 510 and a level two cache 512, a processor core 514, and registers 516. The processor core 514 may include an arithmetic logic unit (ALU), a floating point unit (FPU), a digital signal processing core (DSP Core), or any combination thereof. A memory controller 518 may also be used with the processor 504; or in some implementations, memory controller 518 may be internal to processor 504.

Depending on the desired configuration, system memory 506 may be of any type including but not limited to volatile memory (such as RAM), non-volatile memory (such as ROM, flash memory, etc.) or any combination thereof. System memory 506 may include an operating system 520, one or more applications 522, and program data 524.

Application 522 may include the aforementioned application 200, e.g., client application 526, that may be arranged to perform the functions for masking phone numbers, which are described previously with respect to FIGS. 1-4. Program data 524 may include a table 550, which may be useful for implementing actuation of appropriate components or modules as described herein. For example, table 550 may include catalog information regarding data stored in a local cloud-based service and data center, information regarding other cloud-based service and data centers associated with a particular cloud-based storage service, etc.

System memory 506 is an example of computer storage media. Computer storage media may include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500, as described above, may be implemented as a portion of a small-form factor portable (or mobile) electronic device such as mobile client 102 or, alternatively, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein may be implemented, e.g., hardware, software, and/or firmware, and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes for system configuration 100 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “ a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “ a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A computer-readable medium configured to store one or more executable instructions that, when executed, cause one or more processors to:
subscribe to a cloud service provider;
store a digital catalog to the cloud service provider;
register a point of access for at least a portion of the digital catalog with the cloud service provider; and
receive expedited access to at least the portion of the digital catalog at the registered point of access.

2. The computer-readable medium of claim 1, wherein the one or more executable instructions that cause the one or more processors to subscribe to a cloud service provider include causing the one or more processors to purchase one tier of a layered subscription scheme.

3. The computer-readable medium of claim 1, wherein the one or more executable instructions that cause the one or more processors to store a digital catalog to the cloud service provider include causing the one or more processors to upload the digital catalog to the cloud service provider.

4. The computer-readable medium of claim 1, wherein the one or more executable instructions that, when executed, cause the one or more processors to store a digital catalog to the cloud service provider include causing the one or more processors to categorize the digital catalog based on type of data.

5. The computer-readable medium of claim 4, wherein the type of data includes at least one of digital video, digital audio, or text.

6. The computer-readable medium of claim 1, wherein the one or more executable instructions that cause the one or more processors to store a digital catalog to the cloud service provider include causing the one or more processors to prioritize individual files in the digital catalog.

7. The computer-readable medium of claim 1, wherein the one or more executable instructions that, when executed, cause the one or more processors to register a point of access include causing the one or more processors to relay an itinerary received from a third-party travel entity to the cloud service provider.

8. The computer-readable medium of claim 7, wherein the third-party travel entity is at least one of an airline or a hotel.

9. The computer-readable medium of claim 1, wherein the one or more executable instructions that, when executed, cause the one or more processors to register a point of access include causing the one or more processors to send a list of preferred geographic destinations to the cloud service provider.

10. The computer-readable medium of claim 1, wherein the one or more executable instructions that, when executed, cause the one or more processors to receive expedited access include causing the one or more processors to access at least portions of the stored digital catalog in accordance with at least one of classification and priority.

11. A computer-readable medium configured to store one or more computer-executable modules, including:
a subscriber interface module configured to interact with a subscriber's client application;
a local data center catalog module configured to facilitate storage a digital data catalog for the subscriber in a hierarchical manner based upon a tier of storage service acquired by the subscriber; and
a remote data center interface module configured to facilitate interaction with a remote data center on behalf of the subscriber, including transmission of at least a portion of the digital data to the remote data center in a geographical location designated on behalf of the subscriber.

12. The computer-readable medium of claim 11, wherein the subscriber interface module is further configured to enlist the subscriber to one of multiple tiers of storage service.

13. The computer-readable medium of claim 11, wherein the local data center catalog module is configured to facilitate the storage of the digital data catalog for the subscriber relative to digital data catalogs for other subscribers.

14. The computer-readable medium of claim 11, wherein the local data center catalog module is configured to facilitate the storage of the digital data catalog for the subscriber relative to digital data files that are included in the digital data catalog.

15. The computer-readable medium of claim 11, wherein the remote data center interface module is configured to facilitate interaction with the remote data center on behalf of the subscriber after receiving a travel itinerary for the subscriber.

16. The computer-readable medium of claim 15, wherein the remote data center interface module is further configured to receive the travel itinerary for the subscriber from a third-party travel entity.

17. The computer-readable medium of claim 15, wherein the remote data center interface module is further configured to receive the travel itinerary for the subscriber from the subscriber's client application.

18. The computer-readable medium of claim 13, wherein the remote data interface module is further configured to receive digital data from the remote data center on behalf of the subscriber and to add the received digital data into the subscriber's digital data catalog, and
wherein the remote data center interface module is further configured to facilitate access of an entirety of the subscriber's digital data catalog based on the tier of storage service acquired by the subscriber.

19. The computer-readable medium of claim 14,
wherein the remote data interface module is further configured to receive digital data from the remote data center on behalf of the subscriber and to add the received digital data into the subscriber's digital data catalog, and
wherein the remote data center interface module is further configured to facilitate access of at least portions of the subscriber's digital data catalog based on the tier of storage service acquired by the subscriber.

20. The computer-readable medium of claim 11, wherein the remote data center interface is further configured to retain a copy of the subscriber's digital data catalog in accordance with a highest tier of storage service acquired by the subscriber.
